(19) United States
(12) Patent Application Publication
(10) Pub. No.: US 2026/0014723 A1
(43) Pub. Date: Jan. 15, 2026

(54) COMPOSITE BLADE

(71) Applicant: Chung-Chen TSUI, Xiamen (CN)

(72) Inventor: Chung-Chen TSUI, Xiamen (CN)

(21) Appl. No.: 18/822,317

(22) Filed: Sep. 2, 2024

(30) Foreign Application Priority Data
Jul. 12, 2024 (CN) 2024216454111

(51) Int. Cl. B26B 21/58

(52) U.S. Cl. CPC B26B 21/58

(57) ABSTRACT

A composite blade, including a blade and a sheath, the blade is made of ceramic material. The blade has a body and a cutting edge integrally formed as a whole. The sheath sheaths the blade and retains the cutting edge within the sheath. A plurality of openings are arranged on the sheath in a row spaced apart from one another corresponding to an extending direction of the cutting edge of the blade. The composite blade will not easily cut and hurt users, and can also prevent metal allergic reaction on users.

### BACKGROUND OF THE INVENTION

The present invention relates to the field of bladed tools, and in particular, to a composite blade.

When using an existing bladed tool for removing body hair (such as a shaver and an eyebrow razor), if the blade moves longitudinally along a longitudinal direction of which a cutting edge of the blade extends, the blade might cut and hurt the skin, resulting in bad user's experience. In addition, the blade of the existing bladed tool for removing body hair is generally made of an integral piece of metal, so if the bladed tool is used by a user susceptible to metal allergic reaction, the metal allergic reaction will basically occur on the user during use of the bladed tool, and hence the user with such metal allergic reaction cannot use the bladed tool to remove the body hair, and the use of the bladed tool is therefore limited.

In view of the above problems, it is necessary to develop a composite blade, which has the advantages of not easy to cut and hurt the user and not causing metal allergic reaction to the user.

### BRIEF SUMMARY OF THE INVENTION

It is an object of the present invention is to provide a composite blade, which has the advantages of not easy to cut and hurt a user and not causing metal allergic reaction to the user.

To attain the above object, the present invention provides the following technical solutions:

A composite blade, comprising a blade body and a protective sheath; the blade body is made of a ceramic material; the blade body comprises a blade body part and a cutting edge part integrally formed as a whole; the blade body is fitted in the protective sheath, and the cutting edge part of the blade body is retained within the protective sheath; the protective sheath is provided with a plurality of openings arranged in a row along and spaced apart from one another corresponding to an extending direction of the cutting edge part of the blade body.

The protective sheath comprises a protective part, a first connecting part, and a second connecting part arranged integrally as a whole; the protective part is bent, and two ends of the protective part are connected to the first connecting part and the second connecting part respectively; the first connecting part and the second connecting part of the protective sheath serve to cover two opposite surfaces of the blade body part of the blade body respectively; the protective part of the protective sheath retains a cutting tip portion of the cutting edge part of the blade body within the protective sheath, and the plurality of openings are arranged on the protective part.

The first connecting part and the second connecting part of the protective sheath are connected through an assembly component.

The first connecting part of the protective sheath is provided with at least one first connecting hole, and the second connecting part of the protective sheath is provided with at least one second connecting hole corresponding to said at least one first connecting hole; the assembly component comprises a first assembly member and a second assembly member both made of a plastic material; the first assembly member is provided with at least one assembly column corresponding to said at least one first connecting hole of the first connecting part and said at least one second connecting hole of the second connecting part; the second assembly member is provided with at least one assembly hole corresponding to said at least one first connecting hole of the first connecting part and said at least one second connecting hole of the second connecting part; each said assembly column of the first assembly member passes through a corresponding first connecting hole of the first connecting part, a corresponding second connecting hole of the second connecting part sequentially, and then being connected to a corresponding assembly hole of the second assembly member.

Two ends of the first assembly member are provided with restricting strips respectively; two ends of the blade body part of the blade body abut against the restricting strips respectively.

The blade body part of the blade body is provided with at least one through hole corresponding to said at least one first connecting hole of the first connecting part and said at least one second connecting hole of the second connecting part; each assembly column of the first assembly member passes through the corresponding first connecting hole of the first connecting part, a corresponding through hole of the blade body part, and the corresponding second connecting hole of the second connecting part sequentially, and then being connected to the corresponding assembly hole of the second assembly member.

Each assembly column is welded with the corresponding assembly hole.

The protective sheath is made of a metal material; a protective coating is coated on each of two opposite surfaces of the protective sheath.

The protective coating is made of an acrylic coating material.

According to the technical solutions of the present invention, the blade body is made of a ceramic material, such that the blade body cannot cause a metal allergic reaction to a user. Moreover, the cutting edge part of the blade body is retained within the protective sheath, and the protective sheath is provided with the plurality of openings arranged in a row and spaced apart from one another corresponding to the extending direction of the cutting edge part, the cutting edge part is ensured by the openings to be in contact with body hair so that the body hair can be removed, and when the composite blade of the present invention moves longitudinally along a longitudinal direction of which the cutting edge part of the blade body extends, the protective sheath can separate the skin of the body from being in direct contact with the cutting edge part, thereby avoiding the problem of cutting and hurting the skin.

### BRIEF DESCRIPTION OF THE DRAWINGS

FIG. 1 is an exploded view of the structure of Embodiment I of the present invention.

FIG. 2 is a schematic structural view of Embodiment I of the present invention.

FIG. 3 is a sectional view of Embodiment I of the present invention.

FIG. 4 is an exploded view of the structure of Embodiment II of the present invention.

FIG. 5 is a schematic structural view of Embodiment II of the present invention.

FIG. 6 is a sectional view of Embodiment II of the present invention.

### DESCRIPTION OF REFERENCE NUMERALS

blade body 1,
blade body part 11, through hole 111,
cutting edge part 12,
protective sheath 2, protective part 21, opening 211, first connecting part 22, first connecting hole 221, second connecting part 23, second connecting hole 231, protective coating 20,
assembly component 3, first assembly member 31, assembly column 311, restricting strip 312, second assembly member 32, and assembly hole 321.

### DETAILED DESCRIPTION OF THE INVENTION

To further explain the technical solutions of the present invention, a detailed description of the present invention is provided below through specific embodiments.

### Embodiment I

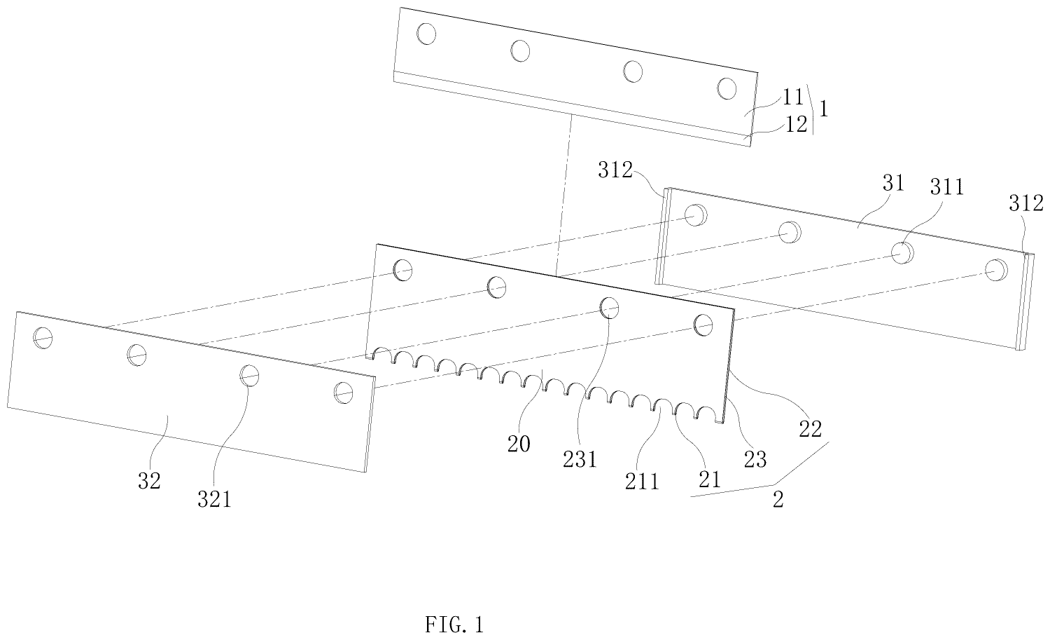

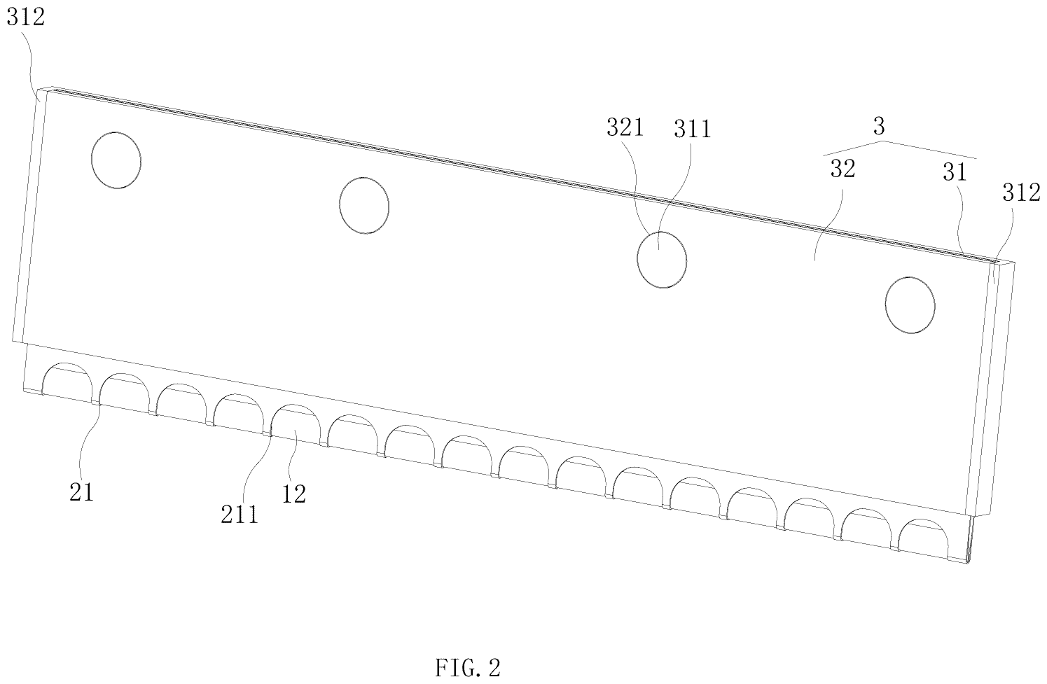

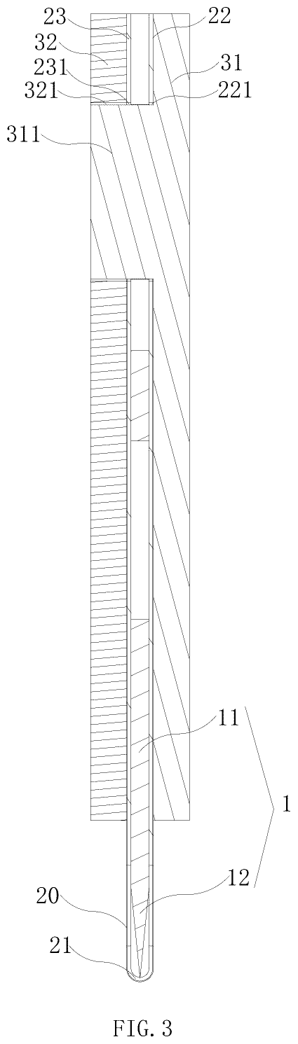

Referring to FIGS. 1 to 3, in Embodiment I of the present invention, a composite blade of the present invention comprises a blade body 1 and a protective sheath 2; the blade body 1 is made of a ceramic material; the blade body 1 comprises a blade body part 11 and a cutting edge part 12 integrally formed as a whole; the blade body 1 is fitted in the protective sheath 2, and the cutting edge part 12 of the blade body 1 is retained within the protective sheath 2; the protective sheath 2 is provided with a plurality of openings 211 arranged in a row along and spaced apart from one another corresponding to an extending direction of the cutting edge part 12 of the blade body 1. According to the present invention, the blade body 1 is made of a ceramic material, such that the blade body 1 cannot cause a metal allergic reaction to a user. Moreover, the cutting edge part 12 of the blade body 1 is retained within the protective sheath 2, and the protective sheath 2 is provided with the plurality of openings 211 arranged in a row and spaced apart from one another corresponding to the extending direction of the cutting edge part 12, the cutting edge part 12 is ensured by the openings 211 to be in contact with body hair so that the body hair can be removed, and when the composite blade of the present invention moves longitudinally along a longitudinal direction of which the cutting edge part 12 of the blade body 1 extends, the protective sheath 2 can separate the skin of the body from being in direct contact with the cutting edge part 12, thereby avoiding the problem of cutting and hurting the skin.

In Embodiment I of the present invention, the protective sheath 2 is made of a metal material, such that the blade body 1 will not damage the protective sheath 2; a protective coating 20 is coated on each of two opposite surfaces of the protective sheath 2 to prevent users from being directly in contact with the protective sheath 2 which may otherwise cause metal allergic reaction to the users; the protective coating 20 can be made of an acrylic coating material.

In Embodiment I of the present invention, the protective sheath 2 comprises a protective part 21, a first connecting part 22, and a second connecting part 23 arranged integrally as a whole; the protective part 21 is bent, and two ends of the protective part 21 are connected to the first connecting part 22 and the second connecting part 23 respectively; the first connecting part 22 and the second connecting part 23 of the protective sheath 2 serve to cover two opposite surfaces of the blade body part 11 of the blade body 1 respectively; the protective part 21 of the protective sheath 2 retains a cutting tip portion of the cutting edge part 12 of the blade body 1 within the protective sheath 2, and the plurality of openings 211 are arranged on the protective part 21.

In Embodiment I of the present invention, the first connecting part 22 and the second connecting part 23 of the protective sheath 2 are connected through an assembly component 3, thereby ensuring that the first connecting part 22 and the second connecting part 23 are stably fitted on the two opposite surfaces of the blade body part 11 of the blade body 1 respectively, and thus further ensuring that the protective part 21 of the protective sheath 2 stably retains the cutting tip portion of the cutting edge part 12 of the blade body 1 within the protective sheath 2. Specifically, the first connecting part 22 of the protective sheath 2 is provided with at least one first connecting hole 221, and the second connecting part 23 of the protective sheath 2 is provided with at least one second connecting hole 231 corresponding to said at least one first connecting hole 221; the assembly component 3 comprises a first assembly member 31 and a second assembly member 32 both made of a plastic material; the first assembly member 31 is provided with at least one assembly column 311 corresponding to said at least one first connecting hole 221 of the first connecting part 22 and said at least one second connecting hole 231 of the second connecting part 23; the second assembly member 32 is provided with at least one assembly hole 321 corresponding to said at least one first connecting hole 221 of the first connecting part 22 and said at least one second connecting hole 231 of the second connecting part 23; each said assembly column 311 of the first assembly member 31 passes through a corresponding first connecting hole 221 of the first connecting part 22, a corresponding second connecting hole 231 of the second connecting part 23 sequentially, and then being connected to a corresponding assembly hole 321 of the second assembly member 32, thereby achieving connection between the first connecting part 22 and the second connecting part 23 through the assembly component 3. Specifically, each assembly column 311 and the corresponding assembly hole 321 may be connected by welding, such that the first assembly member 31 and the second assembly member 32 are firmly connected; the first assembly member 31 and the second assembly member 32 are made of plastic material such that the first assembly member 31 and the second assembly member 32 are prevented from causing metal allergic reaction to the user; two ends of the first assembly member 31 are provided with restricting strips 312 respectively such that two ends of the blade body part 11 of the blade body 1 abut against the restricting strips 312 respectively so as to prevent the blade body 1 from displacement.

### Embodiment II

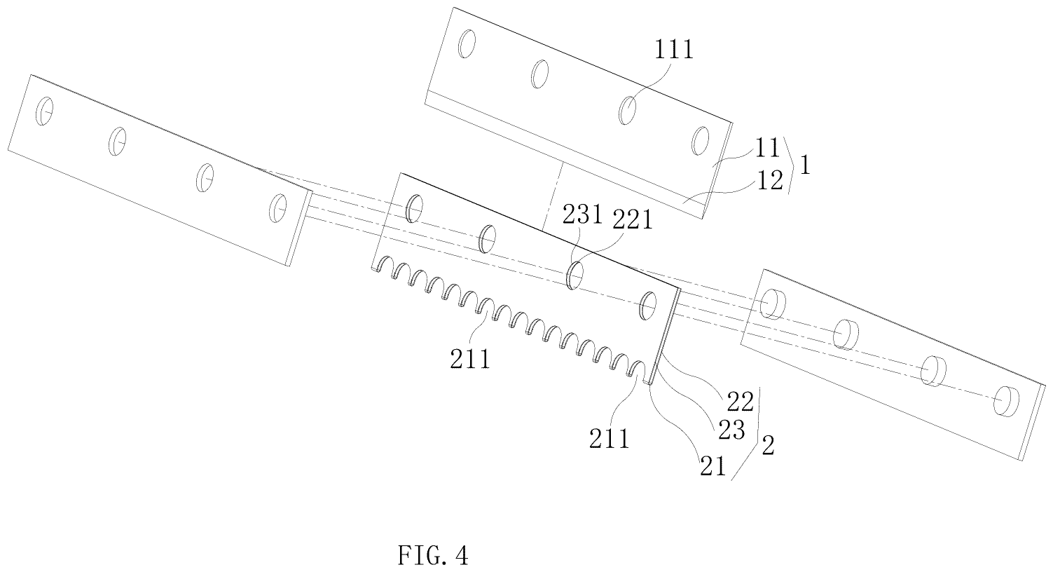

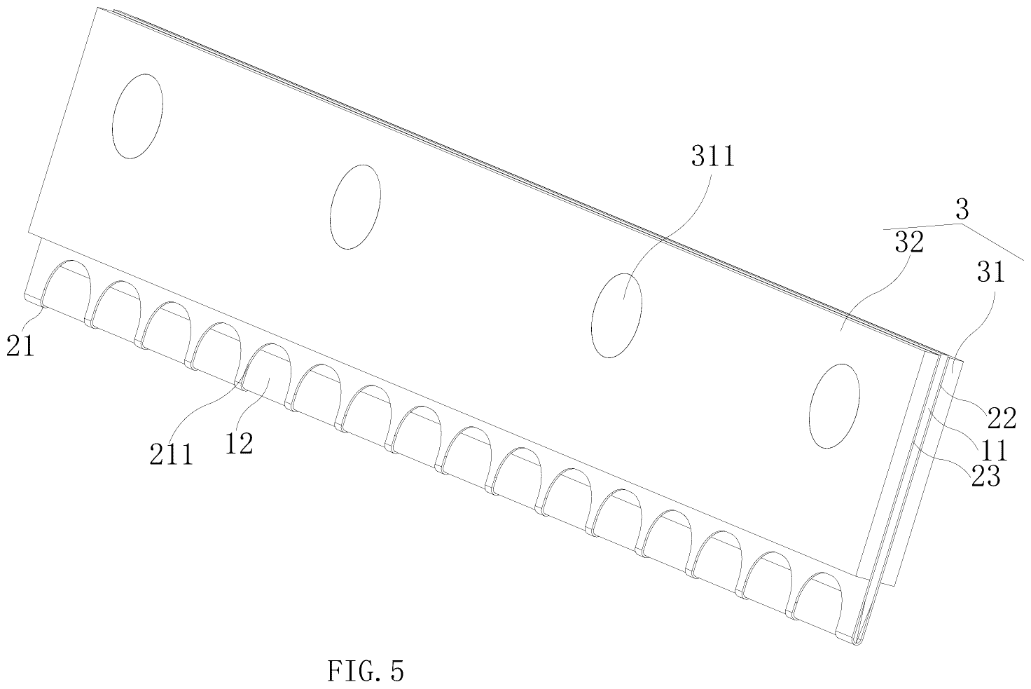

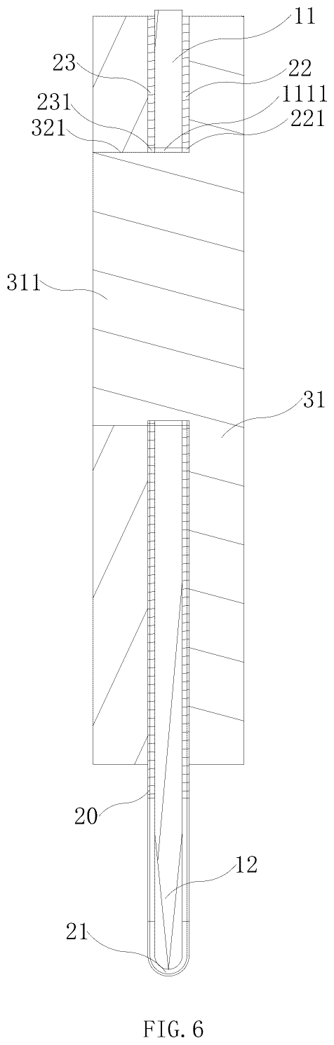

Referring to FIGS. 4 to 6, Embodiment II of the present invention differs from Embodiment I in that: the assembly component 3 according to Embodiment II of the present invention connects the first connecting part 22 and the second connecting part 23 of the protective sheath 2 to the blade body part 11 of the blade body 1, such that the protective sheath 2 is mounted more stably, and displacement of the blade body 1 is prevented.

Specifically, in Embodiment II of the present invention, the first connecting part 22 of the protective sheath 2 is provided with at least one first connecting hole 221, and the second connecting part 23 of the protective sheath 2 is provided with at least one second connecting hole 231 corresponding to said at least one first connecting hole 221; the blade body part 11 of the blade body 1 is provided with at least one through hole 111 corresponding to said at least one first connecting hole 221 of the first connecting part 22 and said at least one second connecting hole 231 of the second connecting part 23; the assembly component 3 comprises a first assembly member 31 and a second assembly member 32 both made of a plastic material; the first assembly member 31 is provided with at least one assembly column 311 corresponding to said at least one first connecting hole 221 of the first connecting part 22, said at least one second connecting hole 231 of the second connecting part 23, and said at least one through hole 111 of the blade body part 11; the second assembly member 32 is provided with at least one assembly hole 321 corresponding to said at least one first connecting hole 221 of the first connecting part 22, said at least one second connecting hole 231 of the second connecting part 23, and said at least one through hole 111 of the blade body part 11; each assembly column 311 of the first assembly member 31 passes through a corresponding first connecting hole 221 of the first connecting part 22, a corresponding through hole 111 of the blade body part 11, and a corresponding second connecting hole 231 of the second connecting part 23 sequentially, and then being connected to a corresponding assembly hole 321 of the second assembly member 32; each assembly column 311 and the corresponding assembly hole 321 are connected by welding.

The above embodiments and illustrations are not intended to limit the form and style of the product of the present invention. Any appropriate variations or modifications made by those of ordinary skills in the art within the scope of the present invention shall be considered as falling within the scope of the present invention.

What is claimed is:

1. A composite blade, comprising a blade body and a protective sheath;
the blade body is made of a ceramic material; the blade body comprises a blade body part and a cutting edge part integrally formed as a whole;
the blade body is fitted in the protective sheath, and the cutting edge part of the blade body is retained within the protective sheath; the protective sheath is provided with a plurality of openings arranged in a row along and spaced apart from one another corresponding to an extending direction of the cutting edge part of the blade body.

2. The composite blade of claim 1, wherein the protective sheath comprises a protective part, a first connecting part, and a second connecting part arranged integrally as a whole; the protective part is bent, and two ends of the protective part are connected to the first connecting part and the second connecting part respectively;
the first connecting part and the second connecting part of the protective sheath serve to cover two opposite surfaces of the blade body part of the blade body respectively; the protective part of the protective sheath retains a cutting tip portion of the cutting edge part of the blade body within the protective sheath, and the plurality of openings are arranged on the protective part.

3. The composite blade of claim 2, wherein the first connecting part and the second connecting part of the protective sheath are connected through an assembly component.

4. The composite blade of claim 3, wherein the first connecting part of the protective sheath is provided with at least one first connecting hole, and the second connecting part of the protective sheath is provided with at least one second connecting hole corresponding to said at least one first connecting hole;
the assembly component comprises a first assembly member and a second assembly member both made of a plastic material; the first assembly member is provided with at least one assembly column corresponding to said at least one first connecting hole of the first connecting part and said at least one second connecting hole of the second connecting part; the second assembly member is provided with at least one assembly hole corresponding to said at least one first connecting hole of the first connecting part and said at least one second connecting hole of the second connecting part; each assembly column of the first assembly member passes through a corresponding first connecting hole of the first connecting part, a corresponding second connecting hole of the second connecting part sequentially, and then being connected to a corresponding assembly hole of the second assembly member.

5. The composite blade of claim 4, wherein two ends of the first assembly member are provided with restricting strips respectively; two ends of the blade body part of the blade body abut against the restricting strips respectively.

6. The composite blade of claim 4, wherein the blade body part of the blade body is provided with at least one through hole corresponding to said at least one first connecting hole of the first connecting part and said at least one second connecting hole of the second connecting part;
each assembly column of the first assembly member passes through the corresponding first connecting hole of the first connecting part, a corresponding through hole of the blade body part, and the corresponding second connecting hole of the second connecting part sequentially, and then being connected to the corresponding assembly hole of the second assembly member.

7. The composite blade of claim 4, wherein each assembly column is welded with the corresponding assembly hole.

8. The composite blade of claim 1, wherein the protective sheath is made of a metal material; a protective coating is coated on each of two opposite surfaces of the protective sheath.

9. The composite blade of claim 8, wherein the protective coating is made of an acrylic coating material.
